(19) United States
(12) Patent Application Publication
(10) Pub. No.: US 2021/0390228 A1
(43) Pub. Date: Dec. 16, 2021

(54) Computer-Aided Method for Simulating the Operation of an Energy System, and Energy Management System

(71) Applicant: Siemens Aktiengesellschaft, München (DE)

(72) Inventor: Sebastian Thiem, Neustadt an der Aisch (DE)

(73) Assignee: Siemens Aktiengesellschaft, München (DE)

(21) Appl. No.: 17/424,723

(22) PCT Filed: Jan. 2, 2020
(86) PCT No.: PCT/EP2020/050026

§ 371 Date: Jul. 21, 2021

(30) Foreign Application Priority Data
Jan. 22, 2019 (DE) 10 2019 200 738.4

(51) Int. Cl. G06F 30/20

(52) U.S. Cl. CPC G06F 30/20; G06F 2119/06

(57) ABSTRACT

Various embodiments include a computer-aided method for simulating the operation of an energy system with a component comprising: modeling the energy system as an optimization problem with energy consumptions and energy outputs of the component and respective shadow prices associated with the energy consumptions and energy outputs as optimization variables; calculating the energy consumptions, the energy outputs, and the respective associated shadow prices by numerically solving the optimization problem; calculating a first sum of the energy consumptions weighted with the associated shadow prices; calculating a second sum of the energy outputs weighted with the associated shadow prices; calculating an incorrect dimensioning variable of the component by subtracting the second sum from the first sum, and using the investment costs and operating costs of the component; and determining overdimensioning or underdimensioning of the component as a function of the calculated incorrect dimensioning variable.

### CROSS-REFERENCE TO RELATED APPLICATIONS

This application is a U.S. National Stage Application of International Application No. PCT/EP2020/050026 filed Jan. 2, 2020, which designates the United States of America, and claims priority to DE Application No. 10 2019 200 738.4 filed Jan. 22, 2019, the contents of which are hereby incorporated by reference in their entirety.

### TECHNICAL FIELD

The present disclosure relates to energy systems. Various embodiments of the teachings herein include computer-aided methods for simulating the operation of an energy system to identify efficient operation of the energy system

### BACKGROUND

Typically, an attempt is made to operate an energy system as efficiently as possible, for example as energy-efficiently as possible. In existing energy systems, the possibilities for optimization are typically limited to the already installed or existing components. The existing energy system thus predetermines the boundary conditions with regard to optimization. Typically, the operation of the energy system is optimized manually. For example, if a component fails, for economic reasons and/or for reasons of innovation, the design of the energy system is redetermined by means of manual optimization. This is effected, for example, by means of an energy system design method or by means of an energy system design. Incorrect dimensioning, that is to say overdimensioning or underdimensioning of one of the components of the energy system, in this case cannot be determined retrospectively, that is to say for already existing or installed energy systems.

### SUMMARY

The teachings of the present disclosure include methods and/or systems for determining incorrect dimensioning of a component of an already existing energy system. For example, some embodiments of the teachings herein include a computer-aided method for simulating the operation of an energy system (1) with at least one component (11, . . . , 19), comprising at least the steps: modeling the energy system (1) as an optimization problem, wherein the optimization problem has at least energy consumptions and energy outputs of the component (11, . . . , 19) as well as respective shadow prices associated with the energy consumptions and energy outputs as optimization variables; calculating the energy consumptions, the energy outputs and the respective associated shadow prices by numerically solving the optimization problem; calculating a first sum by means of a sum of the energy consumptions weighted with the associated shadow prices; calculating a second sum by means of a sum of the energy outputs weighted with the associated shadow prices; calculating an incorrect dimensioning variable of the component (11, . . . , 19) by means of a subtraction of the second sum from the first sum, as well as by means of the investment costs and operating costs of the component (11, . . . , 19); and determining overdimensioning or underdimensioning of the component (11, . . . , 19) as a function of the calculated incorrect dimensioning variable.

In some embodiments, the overdimensioning or underdimensioning of the component (11, . . . , 19) is determined as a function of the sign of the calculated incorrect dimensioning variable.

In some embodiments, the component (11, . . . , 19) is dimensioned to be smaller if the sign of the calculated incorrect dimensioning variable is positive, or in which the component (11, . . . , 19) is dimensioned to be larger if the sign of the calculated incorrect dimensioning variable is negative.

In some embodiments, the operating costs and the investment costs are determined as a function of the nominal power of the component (11, . . . , 19).

In some embodiments, the nominal power is also calculated by solving the optimization problem, wherein the optimization problem is solved under the secondary condition that the calculated nominal power corresponds to the physical nominal power of the component (11, . . . , 19).

In some embodiments, the incorrect dimensioning variable is calculated by means of K=Cⁱⁿ−C^{out}+CAPEX+OPEX, wherein the first sum is designated as Cⁱⁿ, the second sum is designated as C^{out}, the investment costs are designated as CAPEX and the operating costs are designated as OPEX.

In some embodiments, Cⁱⁿ is calculated by means of Cⁱⁿ=Σᵢ₌₁^{I}Σₙ₌₁^{N} (P_{i,n}ⁱⁿ·ΔT)·p_{i,n}ⁱⁿ and C^{out} is calculated by means of C^{out}=Σⱼ₌₁^{J}Σₙ₌₁^{N} (P_{j,n}^{out}·ΔT)·p_{j,n}^{out}, wherein the i-th energy consumption in the time interval ΔT at the time n is designated as P_{i,n}ⁱⁿ·ΔT, the j-th energy output in the time interval ΔT at the time n is designated as P_{j,n}^{out}·ΔT, the shadow price associated with the i-th energy consumption at the time n is designated as p_{i,n}ⁱⁿ, and the shadow price associated with the j-th energy output at the time n is designated as p_{i,n}ⁱⁿ.

In some embodiments, the operation of the energy system (1) is simulated over a year, over a month and/or over a day.

As another example, some embodiments include an energy management system for simulating the operation of an energy system (1) with at least one component (11, . . . , 19), comprising: means for modeling the energy system as an optimization problem, wherein the optimization problem has at least energy consumptions and energy outputs of the component (11, . . . , 19) as well as respective shadow prices associated with the energy consumptions and energy outputs as optimization variables; means for calculating the energy consumptions, the energy outputs and the respective associated shadow prices by numerically solving the optimization problem; means for calculating a first sum by means of a sum of the energy consumptions weighted with the associated shadow prices; means for calculating a second sum by means of a sum of the energy outputs weighted with the associated shadow prices; means for calculating an incorrect dimensioning variable by means of a subtraction of the second sum from the first sum, as well as by means of the investment costs and operating costs of the component (11, . . . , 19); and means for determining overdimensioning or underdimensioning of the component (11, . . . , 19) as a function of the calculated incorrect dimensioning variable.

In some embodiments, there are means for detecting past energy consumptions and energy outputs of the component (11, . . . , 19) of the energy system (1) with regard to the calculated energy consumptions and calculated energy outputs.

In some embodiments, there are means for storing the investment costs and operating costs of the component (11, . . . , 19).

### BRIEF DESCRIPTION OF THE DRAWINGS

Other advantages, features and details of the teachings herein will emerge from the exemplary embodiments described below and with reference to the drawings, in which, schematically:

FIG. 1 shows a circuit diagram of an energy system; and

FIG. 2 shows a Sankey diagram of the energy system.

Elements of the same type, of the same value or having the same effect may be provided with the same reference signs in the figures.

### DETAILED DESCRIPTION

Some embodiments of the teachings herein include a computer-aided method for simulating the operation of an energy system with at least one component comprises at least the following steps:
modeling the energy system as an optimization problem, wherein the optimization problem has at least energy consumptions and energy outputs of the component as well as respective shadow prices associated with the energy consumption and energy output as optimization variables;
calculating the energy consumptions, the energy outputs and the respective associated shadow prices by numerically solving the optimization problem;
calculating a first sum by means of a sum of the energy consumptions weighted with the associated shadow prices;
calculating a second sum by means of a sum of the energy outputs weighted with the associated shadow prices;
calculating an incorrect dimensioning variable of the component by means of a subtraction of the second sum from the first sum, as well as by means of the investment costs and operating costs of the component; and
determining overdimensioning or underdimensioning of the component as a function of the calculated incorrect dimensioning variable.

In some embodiments, there is a method for formulating a (mathematical) optimization problem based on an energy system design problem of the energy system. For this purpose, in a first step, the energy system or the operation of the energy system is formulated or modeled as an optimization problem. Here, the variables of the optimization problem are at least the energy consumptions and energy outputs of the component and the respective shadow prices associated with the energy consumptions and energy outputs. The values of the mentioned variables are therefore calculated as optimally as possible by solving the optimization problem. In other words, the energy consumptions, the energy outputs and the shadow prices associated with the energy consumptions and energy outputs are calculated by numerically solving the optimization problem. When the energy system is modeled as an optimization problem, the existing design of the energy system is taken into account, for example via boundary conditions or secondary conditions of the optimization problem. The energy system is typically modeled by means of an objective function of the optimization problem, wherein the objective function comprises at least the mentioned variables and parameters.

In some embodiments, the first and second sum are calculated from the energy consumptions, energy outputs and associated shadow prices calculated by means of solving the optimization problem (or by means of their calculated values). Here, the first sum is formed by means of the sum of the energy consumptions weighted by the associated shadow prices. The second sum is formed by means of the sum of the energy outputs weighted by the associated shadow prices.

In a further step, the incorrect dimensioning variable of the component is calculated at least by means of a subtraction of the second sum from the first sum. A subtraction of the first sum from the second sum is likewise conceivable.

In some embodiments, the investment costs and the operating costs of the component are likewise taken into account. The operating costs and investment costs can be taken into account in such a way that they are added to the first sum, for example. In other words, the first sum includes all energy consumptions weighted with the associated shadow prices of the component. The operating costs and investment costs can therefore likewise be interpreted as a price-weighted energy consumption. In other words, the incorrect dimensioning of the component depends on the difference between the first sum and the second sum and on the operating costs and investment costs of the component.

Incorrect dimensioning of the component, that is to say overdimensioning or underdimensioning of the component, can be determined by means of the incorrect dimensioning variable. In other words, in a further step of the method according to the invention, the overdimensioning or underdimensioning of the component is determined based on or as a function of the calculated incorrect dimensioning.

The methods described herein can be carried out for already existing energy systems. It is therefore possible to determine whether a component of the energy system is overdimensioned or underdimensioned under real conditions or boundary conditions within the energy system. These methods can likewise be used to determine the best possible design of the component, that is to say a design in which the component is not significantly underdimensioned and not overdimensioned. For example, this is done by means of a new energy system design. If a component of the energy system comprises several units, for example, it is possible to consider adding an additional unit or removing one of the installed units based on the value of the incorrect dimensioning variable. In other words, based on the value of the incorrect dimensioning variable, the component can be increased or decreased in terms of its dimensioning, for example its nominal power and/or capacity.

The methods can symbolically determine the most efficient adjustment screws for the best possible operation or the best possible design of the already existing energy system. This can significantly improve the energy efficiency of the energy system.

Some embodiments of the teachings herein include an energy management system for simulating the operation of an energy system, comprising:
means for modeling the energy system as an optimization problem, wherein the optimization problem has at least energy consumptions and energy outputs of the component as well as respective shadow prices associated with the energy consumption and energy output as optimization variables;
means for calculating the energy consumptions, the energy outputs and the respective associated shadow prices by numerically solving the optimization problem;
means for calculating a first sum by means of a sum of the energy consumptions weighted with the associated shadow prices;
means for calculating a second sum by means of a sum of the energy outputs weighted with the associated shadow prices;
means for calculating an incorrect dimensioning variable by means of a subtraction of the second sum from the first sum, as well as by means of the investment costs and operating costs of the component; and
means for determining overdimensioning or underdimensioning of the component as a function of the calculated incorrect dimensioning variable.

Similar and equivalent advantages of the energy management systems incorporating teachings of the present disclosure result from the methods incorporating the teachings herein.

In some embodiments, the overdimensioning or underdimensioning of the component is determined as a function of the sign of the calculated incorrect dimensioning variable. In other words, the incorrect dimensioning variable can have a negative or positive value. In some embodiments, the incorrect dimensioning variable is set or determined in such a way that the component of the energy system is underdimensioned in the case of a positive value and overdimensioned in the case of a negative value. Of course, the incorrect dimensioning variable can be converted into a large number of mathematically equivalent variables or expressions. It is only decisive that an overdimensioning or an underdimensioning of the component can be determined and differentiated based on the incorrect dimensioning variable, in particular its sign. The component of the energy system is therefore optimally designed or dimensioned if the incorrect dimensioning variable has the value zero.

If the incorrect dimensioning variable has a value different from zero, that is to say a positive or negative value different from zero, it may be efficient to dimension the component to be smaller if the sign of the calculated incorrect dimensioning variable is positive, or to dimension it to be larger if the sign of the calculated incorrect dimensioning variable is negative. A corresponding inverse behavior results when the incorrect dimensioning variable is multiplied by a negative number, in particular by −1.

In some embodiments, the operating costs and the investment costs are determined as a function of the nominal power of the component. The nominal power of the component can also be referred to as the capacity of the component and essentially corresponds to the dimensioning of the component. In other words, the operating costs and the investment costs of the component are dependent on their dimensioning or capacity. When calculating the incorrect dimensioning variable, the dimensioning or the capacity of the physically installed, that is to say the existing, component is taken into account. In other words, the operating costs and investment costs of the component are dependent on its capacity or its nominal power. This dependency is also taken into account when calculating the incorrect dimensioning variable. This advantageously ensures that the method relates to the actually installed or existing energy system.

In some embodiments, the operating costs and investment costs can be stored by means of the energy management system. In other words, the operating costs and investment costs are known to the energy management system.

In some embodiments, the system or method can calculate the nominal power (capacity) by solving the optimization problem, wherein the optimization problem is solved under the secondary condition that the calculated nominal power corresponds to the physical nominal power of the component. As a result, the nominal power of the component, that is to say its capacity or dimensioning, is advantageously initially taken into account as a variable in the optimization problem. However, its value is limited to the actually installed or existing physical nominal power or capacity of the component by means of a secondary condition. As a result, the nominal power, which does form a variable of the optimization problem, is limited to its physical value. As a result, finding a solution to the optimization problem can advantageously be improved, in particular accelerated, by means of numerical methods. In particular, computer resources can be saved as a result.

In some embodiments, the incorrect dimensioning variable is calculated by means of K=Cⁱⁿ− C^{out}+CAPEX+OPEX, wherein the first sum is designated as Cⁱⁿ, the second sum is designated as C^{out}, the investment costs are designated as CAPEX and the operating costs are designated as OPEX.

The incorrect dimensioning variable can also be reformulated to K=Cⁱⁿ+CAPEX+OPEX−C^{out}. This makes it clear that the investment costs CAPEX and operating costs OPEX can be added to the first sum. They can therefore be considered to be basic energy consumptions. It is clear from this that K=O forms an equilibrium for the component, which is characterized in that the component behaves neutrally with regard to energy consumptions and energy outputs weighted with the associated shadow prices. On the other hand, if the incorrect dimensioning variable K is not equal to zero, the component is not in equilibrium with the other components of the energy system, with the result that, for example, for K>0 the component operates at the expense of the other components of the energy system. It is therefore desirable for every component of the energy system to achieve K=0. This is made possible by the present invention and/or one of its embodiments. In other words, each component of the energy system is advantageously dimensioned if the incorrect dimensioning variable associated with the component has the value zero.

In some embodiments, Cⁱⁿ is calculated by means of Cⁱⁿ Σᵢ₌₁^{I}Σₙ₌₁^{N} (P_{i,n}ⁱⁿ·ΔT)·p_{i,n}ⁱⁿ and C^{out} by means of C^{out}=Σⱼ₌₁^{J}Σₙ₌₁^{N} (P_{j,n}^{out}·ΔT)·p_{j,n}^{out}, wherein the i-th energy consumption in the time interval ΔT at the time n is designated as P_{i,n}ⁱⁿ·ΔT, the j-th energy output in the time interval ΔT at the time n is designated as P_{j,n}^{out}·ΔT, the shadow price associated with the i-th energy consumption at the time n is designated as p_{i,n}ⁱⁿ, and the shadow price associated with the j-th energy output at the time n is designated as p_{i,n}ⁱⁿ.

Here there is I energy consumptions and J energy outputs as well N time steps or points in time. In other words, the first sum is essentially the scalar product between the vector formed from the energy consumptions and the vector formed from the shadow prices associated with the energy consumptions. This is done by summing over all points in time or time ranges. Therefore, Cⁱn can also be written as Cⁱⁿ=∫₀^{T} [symbol] Pⁱⁿ (t), pⁱⁿ(t) [symbol] dt=∫₀^{T}Σᵢ₌₁^{I} Pᵢⁱⁿ(t)·pᵢⁱⁿ(t)·dt and/or C^{out} can also be written as C^{out}=∫₀^{T} [symbol] P^{out}(t), p^{out}(t) [symbol] dt=∫₀^{T} Σⱼ₌₁^{I}Pⱼ^{out}(t)·pⱼ^{out}(t)·dt, wherein T indicates the time range of the optimization (optimization horizon), for example a year, a month or a day (day-ahead), and wherein Pⁱⁿ(t)=(P₁ⁱⁿ(t), . . . ,P_{I}ⁱⁿ(t))^{T} indicates the vector of energy consumptions, pⁱⁿ(t)=(p₁ⁱⁿ(t), . . . ,p_{I}ⁱⁿ(t))^{T} the vector of the shadow prices associated with the energy consumptions, P^{out}(t)=(P₁^{out}(t), . . . , P_{J}^{out}(t))^{T} the vector of energy outputs and pⁱⁿ(t)=(p₁^{out}(t), . . . p_{J}^{out}(t))^{T} the vector of the shadow prices associated with the energy outputs. The energy consumptions and energy outputs as well as shadow prices are typically time-dependent, that is to say a function of t.

In some embodiments, the operation of the energy system is simulated over a year, over a month and/or over a day. In other words, the aforementioned optimization horizon is a year, a month, and/or a day. The year can in this case be further divided into smaller time ranges, for example into hours.

In some embodiments, the energy management system comprises means for detecting past or historic energy consumptions and energy outputs of the component of the energy system with regard to the calculated energy consumptions and calculated energy outputs. In other words, historic, that is to say past, energy consumptions and energy outputs of the components are taken into account in the optimizations, for example to initialize the parameters of the optimization problem. This may improve the operation or the detection of the incorrect dimensioning of the at least one component of the energy system.

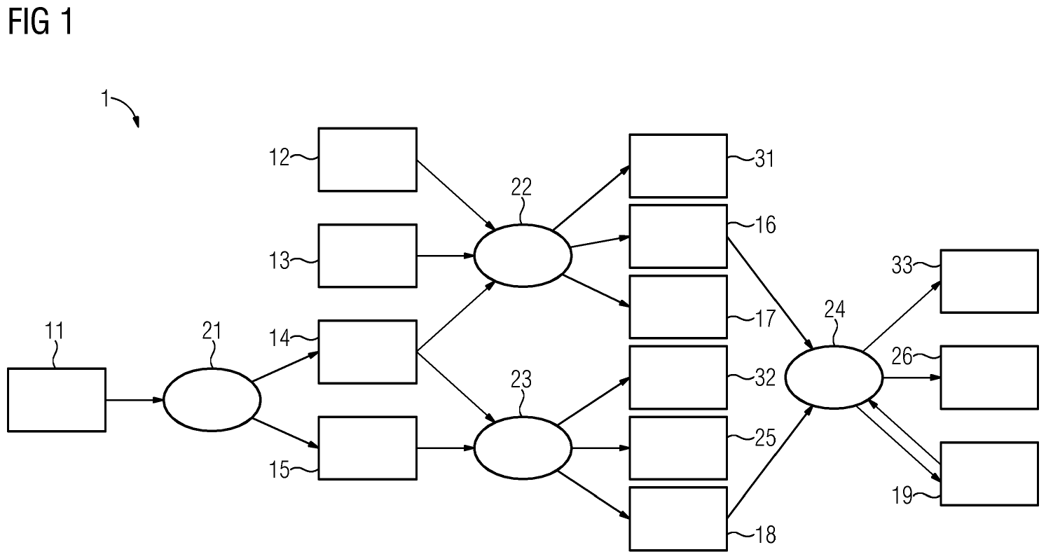

FIG. 1 shows a circuit diagram of the energy system 1. From this, the components 11, . . . , 19 of the energy system 1, the energy demands 31, 32, 33 (loads) and forms of energy 21, . . . , 26 and their dependencies can be recognized. The energy system 1 comprises, for example, as components 11, . . . , 19 a natural gas grid 11, a photovoltaic system 12, an electricity grid 13 for feeding into the energy system 1, a cogeneration unit 14, a gas boiler 15, a compression refrigeration machine 16, an electricity grid 17 for feeding out of the energy system 1, an absorption refrigeration machine 18 and a refrigerant storage means 19. Further components can be provided.

The components 11, . . . , 19 of the energy system 1 are coupled with regard to their energy consumptions and their energy outputs. In some embodiments, natural gas 21 is provided for the cogeneration unit 14 and the gas boiler 15 by means of the natural gas grid 11. In other words, the cogeneration unit 14 and the gas boiler 15 are operated by means of the natural gas 21. The cogeneration unit 14 and the gas boiler 15 convert the natural gas 21 into electrical energy, that is to say electricity 22, and heat 23. In other words, the cogeneration unit 14 provides electricity 22 and heat 23. The gas boiler 15 provides heat 23.

The photovoltaic system 12 and the electricity grid 13 also provide electrical energy, that is to say electricity 22. The electricity 22 and the heat 23 are used within the energy system by other components. For example, the electric current 22 is used to cover the electrical load 31, to operate the compression refrigeration machine 16 and/or to feed it out into the electricity grid 17. The heat 23 provided by the cogeneration unit 14 and the gas boiler 15 can be used to cover the heat load 32 and/or to operate the absorption refrigeration machine 18.

Furthermore, there is a loss of heat, that is to say the waste heat 25. The cold 24 is provided by means of the compression refrigeration machine 16 and the absorption refrigeration machine 18. The cold 24 can be used to cover the cooling demand 33 or cold load 33. In some embodiments, the cold 24 can be stored or temporarily stored by means of the cold store 19. There is also a loss of cold, that is to say the waste cold 26.

FIG. 1 therefore illustrates the complex dependencies of the components 11, . . . , 19 of the energy system 1 with regard to the energy flows, that is to say with regard to their energy consumptions and energy outputs. For example, the absorption refrigeration machine 18 has the heat 23 provided by the cogeneration unit 14 and the gas boiler 15 as energy consumption. The absorption refrigeration machine 18 has the cold 24 as energy output. The cold 24 can in turn be stored by means of the cold store 19. The methods described herein may be used to optimize the dimensioning of the absorption refrigeration machine 18, for example its nominal power or capacity, with regard to its energy consumptions, in this case the heat 23, and its energy outputs, in this case the cold 24. This takes place by means of the incorrect dimensioning variable of the absorption refrigeration machine 18, by means of which an overdimensioning or an underdimensioning of the absorption refrigeration machine 18 can be identified. The incorrect dimensioning variable of the absorption refrigeration machine 18 therefore shows whether an enlargement (underdimensioning of the absorption refrigeration machine 18) or a reduction (overdimensioning of the absorption refrigeration machine 18) is advantageous. This can also be carried out for further components 11, . . . , 19 of the energy system, in particular for all components 11, . . . , 19 of the energy system.

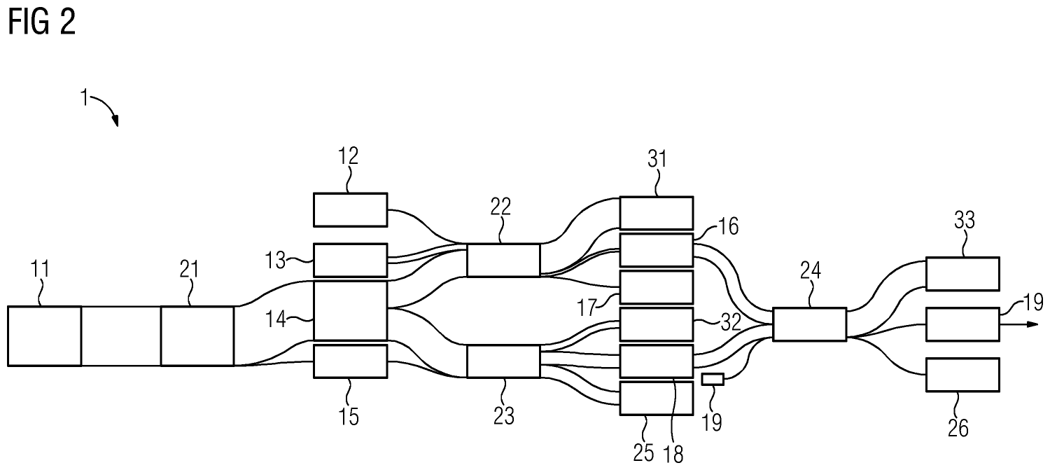

FIG. 2 shows a Sankey diagram of the energy system 1 after the operation of the energy system 1 has been optimized by means of the method according to the invention or one of its embodiments. Annual planning has been carried out here, that is to say the operation of the energy system 1 has been calculated and optimized for the optimization period of one year according to the present invention. In other words, the optimization horizon is one year.

Furthermore, FIG. 2 shows the same elements as FIG. 1 already does. The components 11, . . . , 19 of the energy system 1 are in equilibrium in the solution shown, that is to say they have a value of incorrect dimensioning of zero. The energy consumptions or energy outputs of the components 11, . . . , 19 of the energy system 1 specified below are purely exemplary and the invention is not restricted to the values mentioned. The values are only intended to illustrate the energy flows, that is to say the energy consumptions and energy outputs, within the energy system 1 by way of example. The energy consumptions and energy outputs are symbolized in FIG. 2 by the thickness of the connecting hoses between the elements in FIG. 2, for example in the unit of megawatt hours per year (MWh/a). Furthermore, each component 11, . . . , 19 has a maximum nominal power, for example in the unit of kilowatts (kW).

In FIG. 2, the natural gas grid 11 provides approximately 2656 MWh/a of energy. By means of the cogeneration unit 14, the natural gas 21 is converted, as already explained under FIG. 1, into heat (approximately 1248 MWh/a) and into electrical energy 22 (approximately 770 MWh/a). The photovoltaic system 12 provides about 44 MWh/a and the electricity grid 13 about 303 MWh/a of electrical energy 22 (electricity 22). The electricity 22 and the heat 23 are used, for example, to cover the electrical load 31 and/or to operate the compression refrigeration machine 16 and/or are fed into the electricity grid 13.

The heat 23 is used, for example, for the heat load 32 and/or for operating the absorption refrigeration machine 18. This also results in the waste heat 25. The compression refrigeration machine 16 and the absorption refrigeration machine 18 provide the cold 24. Around 911 MWh/a of cold 24 are provided in this case. The cold 24 can be used to cover the cold load 33 and/or stored or temporarily stored by means of the cold store 19. Furthermore, the waste cold 26 results.

Further illustrations of the energy system 1, for example in the form of a cash flow Sankey diagram can be provided. In particular, a loss and/or revenue of the respective component, which can correspond to positive or negative values of the incorrect dimensioning variable, can also be seen on the cash flow Sankey diagram.

The systems and methods of the present disclosure make it possible for the most optimal possible operation of an energy management system to be formulated as an energy system design problem, wherein inefficient components of the energy system can be determined by means of the incorrect dimensioning variable, in particular using a non-zero value of the incorrect dimensioning variable. In other words, incorrect dimensioning of a component of the energy system can be quantified. As a result, the already existing or installed energy system according to the present invention can be redesigned and/or operated more efficiently. By way of the method according to the invention and/or one of its embodiments, for example by means of annual planning and/or several daily plans (day-ahead), incorrect dimensioning of the energy system or one or more of its components can be detected, checked, avoided and/or tolerated.

Although the teachings herein have been described and illustrated in more detail by way of the exemplary embodiments, the scope of the disclosure is not restricted by the disclosed examples or other variations may be derived therefrom by a person skilled in the art without departing from the scope of protection.

### LIST OF REFERENCE SIGNS

1 Energy system
11 Natural gas grid
12 Photovoltaics
13 Electricity grid (infeed)
14 Cogeneration unit
15 Gas boiler
16 Compression refrigeration machine
17 Electricity grid (outfeed)
18 Absorption refrigeration machine
19 Cold store
21 Natural gas
22 Electricity
23 Heat
24 Cold
25 Waste heat
26 Waste cold
31 Electricity demand
32 Heating demand
33 Cooling demand

What is claimed is:

1. A computer-aided method for simulating the operation of an energy system with a component, the method comprising:
modeling the energy system as an optimization problem with energy consumptions and energy outputs of the component and respective shadow prices associated with the energy consumptions and energy outputs as optimization variables;
calculating the energy consumptions, the energy outputs, and the respective associated shadow prices by numerically solving the optimization problem;
calculating a first sum of the energy consumptions weighted with the associated shadow prices;
calculating a second sum of the energy outputs weighted with the associated shadow prices;
calculating an incorrect dimensioning variable of the component by subtracting the second sum from the first sum, and using the investment costs and operating costs of the component; and
determining overdimensioning or underdimensioning of the component as a function of the calculated incorrect dimensioning variable.

2. The method as claimed in claim 1, wherein determining the overdimensioning or underdimensioning of the component includes calculating a function of the sign of the calculated incorrect dimensioning variable.

3. The method as claimed in claim 2, further comprising dimensioning the component to be smaller if the sign of the calculated incorrect dimensioning variable is positive and to be larger if the sign of the calculated incorrect dimensioning variable is negative.

4. The method as claimed in claim 1, wherein determining the operating costs and the investment costs includes calculating a function of the nominal power of the component.

5. The method as claimed in claim 4, further comprising calculating the nominal power by solving the optimization problem under the secondary condition that the calculated nominal power corresponds to the physical nominal power of the component.

6. The method as claimed in claim 1, wherein calculating the incorrect dimensioning variable includes calculating K=Cⁱⁿ−C^{out}+CAPEX+OPEX, wherein the first sum is designated as Cⁱⁿ, the second sum is designated as C^{out}, the investment costs are designated as CAPEX and the operating costs are designated as OPEX.

7. The method as claimed in claim 6, further comprising calculating Cⁱⁿ using Cⁱⁿ=Σᵢ₌₁^{I}Σₙ₌₁^{N} (P_{i,n}ⁱⁿ·ΔT)·p_{i,n}ⁱⁿ and C^{out} using C^{out}=Σⱼ₌₁^{J}Σₙ₌₁^{N} (P_{j,n}^{out}·ΔT)·p_{j,n}^{out}, wherein the i-th energy consumption in the time interval ΔT at the time n is designated as P_{i,n}ⁱⁿ·ΔT, the j-th energy output in the time interval ΔT at the time n is designated as P_{j,n}^{out}·ΔT, the shadow price associated with the i-th energy consumption at the time n is designated as p_{i,n}ⁱⁿ, and the shadow price associated with the j-th energy output at the time n is designated as p_{i,n}ⁱⁿ.

8. The method as claimed in claim 1, further comprising simulating the operation of the energy system over a year.

9. An energy management system for simulating operation of an energy system with at least one component, the energy management system comprising:
means for modeling the energy system as an optimization problem, wherein the optimization problem has energy consumptions and energy outputs of the component and respective shadow prices associated with the energy consumptions and energy outputs as optimization variables;
means for calculating the energy consumptions, the energy outputs, and the respective associated shadow prices by numerically solving the optimization problem;
means for calculating a first sum by means of a sum of the energy consumptions weighted with the associated shadow prices;
means for calculating a second sum by means of a sum of the energy outputs weighted with the associated shadow prices;
means for calculating an incorrect dimensioning variable by subtracting the second sum from the first sum, as well as by the investment costs and operating costs of the component; and
means for determining overdimensioning or underdimensioning of the component as a function of the calculated incorrect dimensioning variable.

10. The energy management system as claimed in claim 9, further comprising means for detecting past energy consumptions and energy outputs of the component with regard to the calculated energy consumptions and calculated energy outputs.

11. The energy management system as claimed in claim 9, further comprising means for storing the investment costs and operating costs of the component.
